(19) United States
(12) Patent Application Publication
(10) Pub. No.: US 2010/0312503 A1
(43) Pub. Date: Dec. 9, 2010

(54) METHOD FOR DETERMINING FILLING TIME

(75) Inventors: Erhard Fux, Wien (AT); Michael Graf, Gloggnitz (AT)

Correspondence Address: GREENBLUM & BERNSTEIN, P.L.C., 1950 ROLAND CLARKE PLACE, RESTON, VA, 20191, US

(73) Assignee: WITTMANN KUNSTSTOFFGERAETE GMBH, Wien (AT)

(21) Appl. No.: 12/809,484

(22) PCT Filed: Dec. 16, 2008
(86) PCT No.: PCT/AT08/00453

§ 371 Date: Jun. 18, 2010

(30) Foreign Application Priority Data
Dec. 21, 2007 (AT) A 2114/2007

(51) Int. Cl. G01F 23/00

(52) U.S. Cl. 702/55

(57) ABSTRACT

The invention relates to a method for determining the filling time for filling at least one material separator (1) provided with a fill level sensor (12) and a requirement sensor (11) in delivery systems made of at least one reservoir (4) with bulk material. In the beginning, with empty lines (3, 6) and an empty material separator (1), the bulk material is delivered out of the reservoir (4) from the time the requirement sensor (11) is triggered until the fill level sensor (12) is triggered, and said delivery time (T_{REF1}) is measured and stored. If the requirement sensor (11) is triggered again, the delivery is carried out again until the fill level sensor (12) is triggered, and said delivery time (T_{REF2}), which corresponds to the delivery time for filling the material separator (1), is measured and stored, whereby bulk material is present in the lines (3, 6) from the first delivery. The delivery time (T_{REF2}) is subtracted from the delivery time (T_{REF1}) in order to determine the emptying time (T_{LEER}), which is equal to the intake time. The lines (3, 6) are emptied within the calculated emptying time (T_{LEER}). If the requirement sensor (11) is activated again, the material separator (1) is filled within the delivery time (T_{REF2}) and emptied within the emptying time (T_{LEER}), which both represent the filling time when added together.

### CROSS-REFERENCE TO RELATED APPLICATIONS

The present application is a U.S. National Stage of International Patent Application No. PCT/AT2008/000453 filed Dec. 16, 2008, and claims priority under 35 U.S.C. §119 and 365 of Austrian Patent Application No. A 2114/2007 filed Dec. 21, 2007. Moreover, the disclosure of International Patent Application No. PCT/AT2008/000453 is expressly incorporated by reference herein in its entirety.

### BACKGROUND OF THE INVENTION

1. Field of the Invention

The invention relates to a method for determining the filling time for filling at least one material separator provided with a fill level sensor and a requirement sensor in delivery systems made of at least one reservoir with bulk material, in particular in suction delivery systems with preferably plastic granules for machines processing plastic granules.

2. Discussion of Background Information

Material separators of this type, also known as bulk material separators, are combined either as a single unit or, if more than one are provided, into a delivery system and connected with a reservoir through lines. The bulk material is delivered by an air flow, preferably through a suction air flow. Predominantly, all settings are performed manually.

Suction delivery systems of this type are known per se, for example from DE 298 15 537 U1, in which delivery gas or delivery air is supplied through a revolving control collar.

Another delivery system is known from EP 0 386 637 A1, which serves for detergent metering units. In order to enable automatic and particularly quick metering with such a device, a valve is provided for the compressed air for pneumatic delivery of the powder between the supply and the metering vessel, which can be operated by a control unit.

Furthermore, a device for the delivery of bulk material is also known from DE 100 39 564 A1. In the case of this suction delivery system, a delivery gas is loaded at a variable quantity in addition to the bulk material to be delivered. In a delivery line of the bulk material already delivered by the suction delivery unit under additional loading of the delivery gas, the negative pressure is recordable by a pressure gauge assembly and a relevant control signal is generated. A valve is installed in a supply unit of the delivery gas into the suction delivery device, of which the opening for the passing delivery gas can be controlled by means of a control array depending on the level of negative pressure in the delivery line.

The main disadvantage on all of the devices cited above is that although attention is paid to the quantity of air added to the bulk material, the filling time is ignored. This can lead to a poor utilization in the case of short delivery times and deposits of the bulk material in the lines in the case of long delivery times.

### SUMMARY OF THE INVENTION

The present invention is directed to a method of the above-mentioned type which avoids the disadvantages above. Moreover, through the implementation of the method, a rational operation of such a delivery system is enabled.

The method in accordance with the invention is characterized by the fact that
in the beginning, with empty lines and an empty material separator, the bulk material is delivered out of the reservoir from the time the requirement sensor is triggered until the fill level sensor is triggered, and a delivery time (T_{REF1}) is measured and stored,
if the requirement sensor is triggered again, the delivery is carried out again until the fill level sensor is triggered, and a delivery time (T_{REF2}), which corresponds to the delivery time for filling the material separator, is measured and stored. In this regard, bulk material is present in the lines from the first delivery,
the delivery time (T_{REF2}) is subtracted from the delivery time (T_{REF1}) in order to determine the emptying time (T_{LEER}), which is equal to the intake time,
the lines are emptied within the calculated emptying time (T_{LEER}),
if the requirement sensor is activated again, the material separator is filled within the delivery time (T_{REF2}) and emptied within the emptying time (T_{LEER}), which both represent the filling time when added together.

With this invention, it is for the first time possible, in particular in the case of a system restart or after a change of the bulk material, to automatically determine the filling time for filling material separators in delivery systems from a reservoir with bulk material, in particular in suction delivery systems with preferably plastic granules for machines processing plastic granules.

With this permanent and performance-based control of delivery and emptying times in accordance with the invention, the times for filling are adjusted fully automatically to the system parameters. As already generally known, these system parameters are known to drift and are never constant. Due to the fully automatic adjustment in accordance with the invention, these deviations are recorded and compensated.

Without the method in accordance with the invention, these values must be adjusted manually and practically without interruption. The advantage of the method in accordance with the invention is that no manual adjustments requiring staff members with many years of experience need to be made anymore. Furthermore, it is advantageous that no material is left in the lines due to the emptying, which could lead to obstructions and service interruptions of the overall system. Obstructions of this kind may occur relatively quickly if the material is remoistened.

In accordance with a further embodiment of the invention, the actual delivery time in cyclical filling mode is calculated shorter, preferably at ⅔ of the delivery time (T_{REF2}). Tests with a prototype system using the method in accordance with the invention have shown that such a shortened delivery time is sufficient for rational operation.

In accordance with a special feature of the invention, the delivery time, preferably the delivery time ⅔ (T_{REF2}), is shortened by a defined unit of time if the fill level sensor is triggered resp. the delivery time is extended by a defined unit of time if it is not triggered. This way, the advantage is provided that automatic leveling out of the delivery time to an operating value for optimal operation is ensured.

In accordance with one embodiment of the invention, a second emptying is performed if the fill level sensor is triggered during emptying. This way, it is ensured that no bulk material is left in the lines for a longer period of time. It is ensured that the line is free from bulk material after the filling process.

In accordance with another feature of the invention, the time (T₀) from the time the fill level sensor is triggered until the end of the emptying time (T_{LEER}) is measured and stored during emptying. This way, the emptying time can be adapted to the system-specific conditions, such as pipe lengths or the like, depending on the quantity of bulk material supplied.

In accordance with another special feature of the invention, the actual emptying time (T_{t LEER}) is calculated. In this manner, the time (T₀) is subtracted from the emptying time (T_{LEER}). This actual emptying time is then adjusted automatically when the system is in operation and rational operation is enabled.

In accordance with a special embodiment of the invention, the actual emptying time (T_{t LEER}) is not calculated until multiple, in particular five, cyclical filling operations have been performed. This way, it is ensured that practically the optimal value for the delivery time has been determined already. Thus, the adjustment of the emptying time is more or less superimposed on the delivery control.

### BRIEF DESCRIPTION OF THE DRAWINGS

The invention is explained in more detail based on the design examples illustrated in the figure.

FIG. 1 schematically illustrates a system with material separators, and

FIG. 2 illustrates a flow chart of the method.

### DETAILED DESCRIPTION OF THE EMBODIMENTS OF THE INVENTION

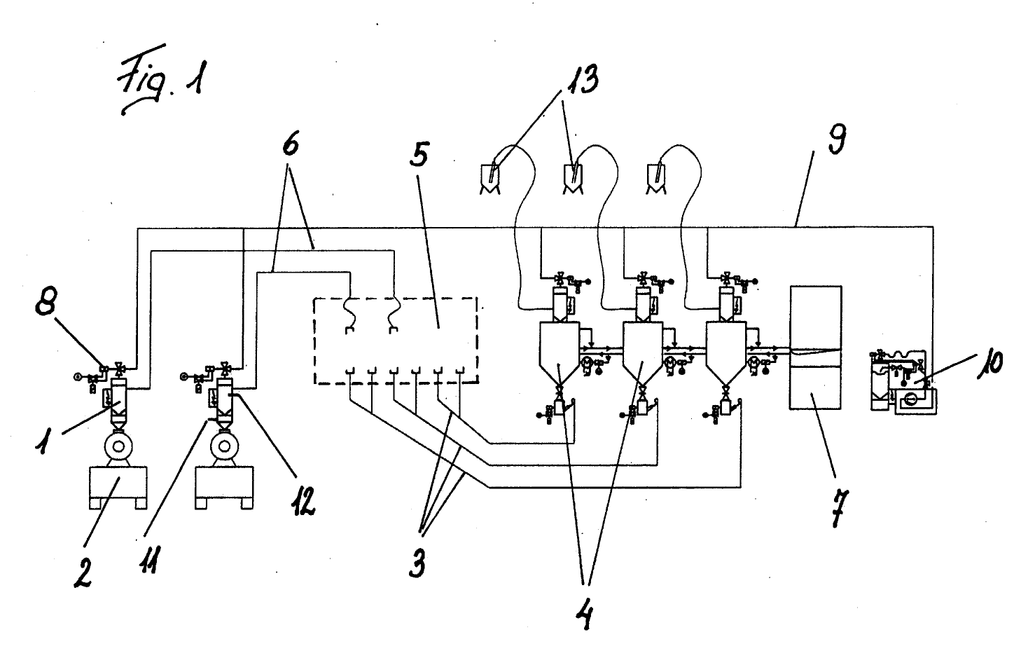

In accordance with FIG. 1, a suction delivery system for material separators 1 for machines processing plastic granules 2 is shown schematically. These material separators 1 obtain the plastic granules from reservoirs 4 through lines 3, 6. In order to supply the relevant plastic granules from the various reservoirs 4 to the material separator 1 provided for this purpose, a coupling station 5 is provided. In this coupling station, the line 6 leading to the material separator 1 can be connected with the lines 3 coming from the reservoir 4. The reservoirs 4 are connected with a dry-air drier 7.

The reservoirs 4, on the other hand, respectively obtain the plastic granules from receptacles 13. In this way, the reservoirs can be filled in analogy to the material separators 1.

The suction air required for a suction delivery system is sucked in through relevant fittings 8 with valves, which are provided on the material separators 1. This suction air is supplied to a two-phase filter system 10 for cleaning through a central suction line 9.

For filling the material separator 1, the same is provided with a requirement sensor 11 and a fill level sensor 12.

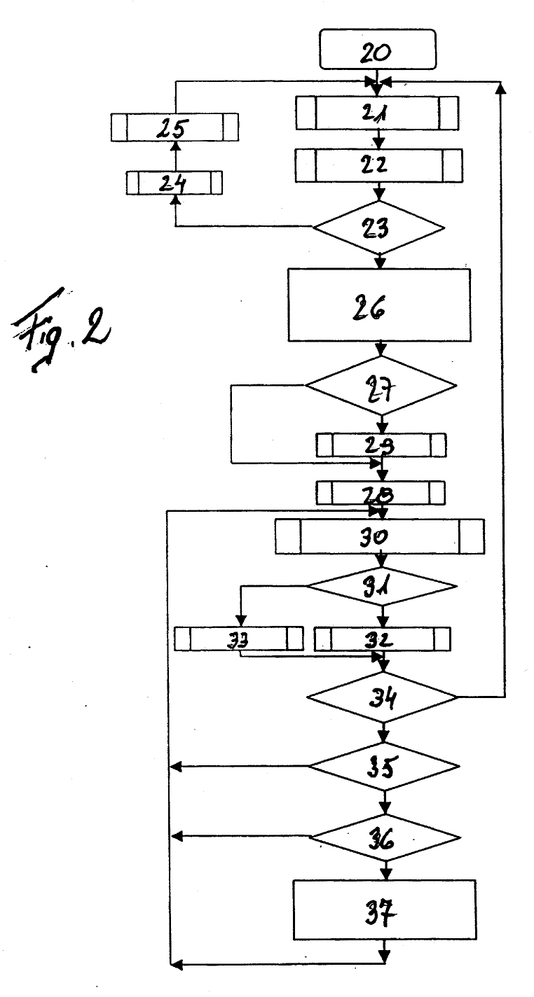

A flow chart of the method is shown in accordance with FIG. 2. This method serves for determining the filling time for filling a material separator 1 in delivery systems from a reservoir 4 with bulk material. This delivery system is in particular a suction delivery system and designed preferably for plastic granules for machines processing plastic granules 2.

As already explained within the scope of FIG. 1, the material separator 1 is provided with a fill level sensor 12 and a requirement sensor 11.

The filling time is determined under the conditions that the lines 3, 6 are empty and no other or additional material separator 1 is supplied from the same line 3 until filling is completed.

The following occurs in the case of a start—step 20—or restart under the conditions above: in the beginning, with empty lines and an empty material separator 1, the bulk material is delivered out of the reservoir 4 from the time the requirement sensor 11 is triggered until the fill level sensor 12 is triggered, and the delivery time (T_{REF1})—step 21—is measured and stored.

If the requirement sensor 11 is triggered again, the delivery is carried out again until the fill level sensor 12 is triggered, and the delivery time (T_{REF2})—step 22—which corresponds to the delivery time for filling the material separator 1, is measured and stored. It is understood that the bulk material from the first delivery is present in the lines 3, 6.

The delivery time (T_{REF2}) is subtracted—in step 23—from the delivery time (T_{REF1}) in order to determine the emptying time (T_{LEER}), which is equal to the intake time. If, for example, the delivery time (T_{REF2}) is greater than the delivery time (T_{REF1}), then an error 24 has occurred and the system is emptied 25. Then the system is restarted.

In principal, if the requirement sensor 11 is activated again, the material separator 1 could now be filled—step 30—within the delivery time (T_{REF2}) and emptied within the emptying time (T_{LEER}), which both represent the filling time when added together.

Based on experiences gained in prototype runs, the actual delivery time in cyclical filling mode—in step 26—is calculated shorter, preferably at ⅔ of the delivery time (T_{REF2}), if required. The emptying time (T_{LEER}) is equivalent to the delivery time (T_{REF1}) minus ⅔ of the delivery time (T_{REF2}).

In the next step 27, it is checked whether the delivery time is shorter than the emptying time (T_{LEER}). If the emptying time (T_{LEER}) is actually shorter, only one emptying is performed using the calculated emptying time (T_{LEER})—step 28—, otherwise a second emptying—step 29—would have to be performed. Thus, a second emptying is performed if the fill level sensor 12 is triggered during emptying.

If the requirement sensor 11 is activated again, the material separator 1 is filled—step 30—within the shortened delivery time (T_{REF2}) and emptied within the extended emptying time (T_{LEER}), which both represent the filling time when added together.

In step 31, it is checked whether the fill level sensor 12 is triggered. If the fill level sensor 12 is triggered, then the delivery time, preferably the delivery time ⅔ (T_{REF2}), is shortened—step 32—by a defined unit of time, but if the fill level sensor is not triggered, then the delivery time is extended—step 33—by a defined unit of time.

In the next step 34, the negative pressure is checked through a manometric switch. If the manometric switch is triggered, thus in the case of high negative pressure, then an obstruction is assumed. The system must be cleaned and a restart follows.

During emptying, the time (T₀) from the time the fill level sensor 12 is triggered until the end of the emptying time (T_{LEER}) is measured and stored. In addition, the actual emptying time (T_{t LEER}) is calculated, whereby the time (T₀) is subtracted—step 35—from the emptying time (T_{LEER}).

The actual emptying time (T_{t LEER}) is not calculated until multiple, in particular five, cyclical filling operations—step 36—have been performed.

In step 37, filling of the material separator 1 is performed within the optimal filling time and the optimal emptying time.

With this permanent and performance-based control of delivery and emptying times, the times for filling are adjusted fully automatically to the system parameters. This way, continuous operation is ensured and possible human shortcomings are ruled out.

1.-7. (canceled)

8. A method for determining the filling time for filling at least one material separator in delivery systems made of at least one reservoir with bulk material, the at least one material separator including a fill level sensor and a requirement sensor, the method comprising:
when the lines and material separator are empty and the requirement sensor is triggered, delivering the bulk material out of the reservoir from a time at which the requirement sensor is triggered until a time at which the fill level sensor is triggered;
measuring and storing a delivery time (T_{REF1});
when the requirement sensor is subsequently triggered, delivering the bulk material out of the reservoir until the fill level sensor (12) is triggered,
measuring and storing a delivery time (T_{REF2}) corresponding to a delivery time for filling the material separator when bulk material is present in the lines from a previous delivery;
calculating an emptying time (T_{LEER}) by subtracting the delivery time (T_{REF2}) from the delivery time (T_{REF1}), wherein the emptying time is equal to an intake time,
emptying the lines within the calculated emptying time (T_{LEER});
when the requirement sensor is triggered after the subsequent triggering, filling the material separator within the delivery time (T_{REF2}) and emptying within the emptying time (T_{LEER}), whereby the sum of the delivery time (T_{REF2}) and the emptying time (T_{LEER}) is the delivery time (T_{REF1}).

9. The method in accordance with claim 8, wherein the delivery system comprises in suction delivery system for machines processing plastic granules and the bulk material comprises plastic granules.

10. The method in accordance with claim 8, wherein in a cyclic filling mode, the method further comprises calculating a shorter actual delivery time as ⅔ of the delivery time (T_{REF2}).

11. The method in accordance with claim 8, wherein, when the fill level sensor is triggered, the delivery time is shortened by a defined unit of time; and
wherein, when the fill level sensor is not triggered, the delivery time is extended by a defined unit of time.

12. The method in accordance with claim 11, wherein the delivery time is ⅔ of the delivery time (T_{REF2}).

13. The method in accordance with claim 8, wherein, when the fill level sensor is triggered during the emptying, the method further comprises performing a second emptying.

14. The method in accordance with claim 8, wherein, during the emptying, the method further comprises measuring and storing a time (T₀) from the time the fill level sensor is triggered until an end of the emptying time (T_{LEER}).

15. The method in accordance with claim 14, further comprising calculating an actual emptying time (T_{t LEER}), whereby the time (T₀) is subtracted from the emptying time (T_{LEER}).

16. The method in accordance with claim 15, wherein the actual emptying time (T_{t LEER}) is not calculated until multiple cyclical filling operations have been performed.

17. The method in accordance with claim 15, wherein the actual emptying time (T_{t LEER}) is not calculated until five cyclical filling operations have been performed.
